(19) United States
(12) Patent Application Publication
(10) Pub. No.: US 2005/0026015 A1
(43) Pub. Date: Feb. 3, 2005

(54) Micro heat pipe embedded bipolar plate for fuel cell stacks

(76) Inventor: Amir Faghri, Mansfield, CT (US)

Correspondence Address: EDWARDS & ANGELL, LLP, P.O. BOX 55874, BOSTON, MA, 02205, US

(21) Appl. No.: 10/632,440

(22) Filed: Jul. 31, 2003

(51) Int. Cl. H01M 8/04; H01M 8/24

(52) U.S. Cl. 429/26; 429/34

(57) ABSTRACT

The present invention is directed to a system and method for distributing heat in a fuel cell stack through bipolar interconnection plates having one or more heat pipes disposed within the plate.

### BACKGROUND OF THE INVENTION

1. Field of the Invention

The present invention is directed to a system and method for thermal management in a fuel cell stack. More particularly, it relates to a system and method for employing heat pipes in bipolar interconnection plates positioned between individual fuel cell units in a fuel cell stack to distribute heat more effectively within the fuel cell stack.

2. Background of the Related Art

Fuel cells are electrochemical engines that are typically formed by two thin, planar, catalytically activated membrane electrodes separated into an anode side and a cathode side by an electrolyte. A fuel gas is supplied to the anode side and an oxidant gas is supplied to the cathode side to produce the reduction and oxidation reactions that establish an external current flow. The electrolyte between the anode and cathode allows only ions to pass through from the anode to the cathode so the reactions proceed continuously.

For example, in one known type of fuel cell, hydrogen is used as the fuel gas, oxygen is used as the oxidant gas and a solid polymer forms the electrolyte. The reaction at the anode side occurs as follows:
2H₂→4H⁺+4e⁻

The electrons are drawn from this reaction to an external circuit while the solid polymer electrolyte permits the H⁺ to pass through to the cathode side. The H⁺ at the cathode reacts with oxygen and externally supplied electrons to form water as shown by the reaction below.
O₂+4H⁺+4e⁻→2H₂O

To produce a useful power output, fuel cells are connected in series to form what is referred to as a fuel cell “stack.” A bipolar plate is used to facilitate the electrical interconnection between each fuel cell in the stack. A first side of the bipolar plate contacts the cathode of a first fuel cell and the opposing second side of the bipolar plate contacts the anode of an adjacent second fuel cell, while at the same time allowing gas flow into the stack with strict separation of oxidant gas flow to the cathode and fuel gas flow to the anode. Bipolar plates are also structural components of a cell stack since the cells are typically subject to compression forces that maintain the entire assembly internally sealed and with good electrical contact along the series of cells. The plates are often formed of electrically conductive coated solid metals, carbon, or graphite/graphite composites that must be machined to provide channels for the required flow fields on both sides and provide a minimum thickness for structural support.

Heat is also released by the fuel cell reactions. Thus, the bipolar plate may also contain conduits for heat transfer. However, in a stack containing many fuel cells, heat generation presents challenges that require a more effective thermal management system. For example, stacks operating at 30% to 50% efficiency generate heat at the same rate to more than twice the rate of electric generation.

One of the biggest problems for thermal management is that the generation of heat throughout the stack is not always uniform. This usually occurs for reasons such as changes in species concentration, temperature gradients, and in some cases phase changes within the stack. Regardless of its cause, non-uniform heat generation increases the amount of thermal gradients within the stack making it more difficult to maintain thermal control. Fluctuations in temperature throughout the stack can lead to reduced efficiency, lower power generation and even stack failure due to overheating.

Sufficient heat distribution can help maintain the stack at a temperature closer to the design temperature, achieve better power density and operate with higher efficiency. In addition to improving operation of the fuel cell stack and reducing the risk of stack failure due to overheating, increasing the mobility of the heat can provide other benefits. The heat generated by the reactions, if properly distributed and managed, can be used in reactant preheating, prevaporization, combined cycle operation, or cogeneration.

One method for improving heat transfer in fuel cell stacks which currently exists involves simply changing the stack geometry, that is, making the stack thinner so heat has less distance to travel. This method results in a stack of increased size and weight, particularly as power requirements increase, which makes it difficult, if not impossible, to use a stack created in accordance with this method in certain fuel cell portable power and transportation applications, among others. Another method involves increasing the thermal conductivity of the bipolar plate material. However, this method is significantly less effective as the size of the stack increases and may also result in comparatively heavier, or structurally weaker stacks depending on the material used.

The remaining known methods employed in some fuel cell stack designs are classified as pumped thermal control. One such variation of pumped thermal control involves the use of a reactant stream as a heat transfer medium. However, this type of pumped thermal control requires greater power than normal in order to pump the stream through the stack and presents new issues with respect to maintaining the separation of reactants from products. Thus, the predominant pumped thermal control method involves a dedicated (non-reacting) fluid stream.

Although the mode of heat transfer employed by this method is primarily single phase, the dedicated stream may be a liquid, gas, or combination thereof. The major disadvantages associated with this method include the added expense for additional power needed to pump the stream through dedicated channels and structural integrity and usefulness issues relating to the comparatively increased stack size needed to accommodate the dedicated channels. This pumped thermal control method may also be adapted to handle a two-phase single species heat transfer medium, which generally requires less power for pumping and causes less issues relating to stack size and structural integrity, but difficulties arise with regard to containing the fluid within the dedicated channels.

Thus, what is needed is a system and method of heat distribution in fuel cell stacks that solves the problems associated with the prior art systems and methods without significantly impairing the structural integrity, increasing the expense to build and/or operate the fuel cell stack or reducing the usefulness of the stack in varied applications.

### SUMMARY OF THE DISCLOSURE

The present invention is directed to a system and method for distributing heat in fuel cell stacks that solves the problems associated with the prior art systems and methods without significantly impairing the structural integrity, increasing the expense to build and operate or reducing the usefulness of the stack in varied applications. The present invention is directed to bipolar interconnection plates that distribute heat more effectively through the use of heat pipes disposed within the plate itself.

In particulars the present invention is directed to a bipolar interconnection plate for placement between fuel cell units in a fuel cell stack having multiple fuel cell units to form a power generation system, wherein each fuel cell unit includes an anode member, a cathode member, and a portion of electrolyte material positioned between the anode member and the cathode member. The bipolar interconnection plate of the present invention includes a generally planar support member having opposing first side and second side surfaces, an elongate channel and lands adjacent thereto defined on the first side surface of the support member, an elongate channel and lands adjacent thereto defined on the second side surface of the support member, and a heat pipe disposed in the planar support member for receiving and distributing heat in the fuel cell stack.

In accordance with the present invention, the heat pipes are preferably embedded in one of the lands defined on either the first side surface or the second side surface. A first heat pipe can be embedded within one of the lands on the first side surface and a second heat pipe can be embedded within one of the lands on the second side surface.

The bipolar plate may have a plurality of elongate channels defining a longitudinal array of lands adjacent thereto on the first side surface and a plurality of elongate channels defining a longitudinal array of lands adjacent thereto on the second side surface. Thus, in accordance with the present invention, a heat pipe can be embedded in each of the longitudinal lands defined by the plurality of elongate channels on the first side surface and a heat pipe can be embedded in each of the longitudinal lands defined by the plurality of elongate channels on the second side surface. In order to better meet the needs for separation of fuel and oxidant gases in the fuel cell stack, the plurality of elongate channels and array of longitudinal lands with embedded heat pipes on the first side of the support member and the plurality of elongate channels and array of longitudinal lands with embedded heat pipes on the second side of the support member can be in a perpendicular relationship with respect to each other.

In accordance with the present invention, the heat pipes can extend substantially the length of the support member and the heat pipe working fluid can be liquid metal.

The present invention, as compared with pumped thermal control systems, even those with two phase heat transfer, fluid containment is simplified, especially during stack assembly. Heat pipes can be compact (referred to herein as “micro” heat pipes) and not significantly increase the size or weight of the fuel cell stack. Furthermore, heat pipes are passive devices, which does not require separate controls, thus providing a simpler overall system without parasitic power losses. The characteristic isothermal operation of heat pipes in the present system provides greater temperature uniformity within the stack than prior art heat transfer systems.

Thus, the present invention is also directed to a fuel cell stack including multiple fuel cell units forming a power generation system, wherein each fuel cell unit includes an anode member, a cathode member, and a portion of electrolyte material positioned between the anode member and the cathode member, and a bipolar interconnection plate constructed in accordance with the present invention for placement between at least one pair of adjacent fuel cell units in the fuel cell stack.

The bipolar interconnection plate of this embodiment includes a generally planar support member having opposing first side and second side surfaces, a plurality of elongate channels and lands defined adjacently thereto on the first side surface of the support member, a plurality of elongate channels and lands defined adjacently thereto on the second side surface of the support member. A first heat pipe is disposed within at least one of the lands of the first side of the support member and a second heat pipe is disposed within at least one of the lands of the second side of the support member for receiving and distributing heat within the fuel cell stack.

In accordance with the present invention, the lands and channels on the first side surface can be defined substantially perpendicular with respect to the lands and channels on the second side surface. Therefore, a heat pipe can be disposed within each of the lands of the first side of the support member and a heat pipe can be disposed within each of the lands of the second side of the support member. Also, the heat pipes can be substantially embedded in the support member. The bipolar interconnection plate constructed in accordance with the present invention can be placed between each fuel cell unit in the stack.

The present invention is also directed to a method for constructing a bipolar interconnection plate. In this embodiment, a machined bipolar interconnection plate is provided. The plate includes a planar support member having opposing first side and second side surfaces, an array of elongate channels and lands adjacent thereto defined on the first side surface of the support member, and an array of elongate channels and lands adjacent thereto defined on the second side surface of the support member.

A bore is formed through the support member in the area of at least one of the lands on the first side of the support member and a heat pipe is secured within the bore. A bore can also be formed through the support member in the area of at least one of the lands on the second side of the support member and a heat pipe can be secured within that bore. These bores may be formed through laser drilling and the heat pipes can be sealed within the bores using a highly thermally conductive epoxy.

The proposed micro heat pipe embedded bipolar plate is an innovative device that would increase heat transfer in fuel cell stacks while requiring significantly smaller thermal gradients and much less volume and weight than alternative methods.

These and other aspects of the system and method of the present invention will become more readily apparent to those having ordinary skill in the art from the following detailed description of the invention taken in conjunction with the drawings.

### BRIEF DESCRIPTION OF THE FIGURES

So that those having ordinary skill in the art to which the present invention pertains will more readily understand how to make and use the method and system of the present invention, embodiments thereof will be described in detail with reference to the drawings, wherein:

FIG. 1 top perspective view of a first side of an exemplary bipolar interconnection plate constructed in accordance with the present invention having embedded micro heat pipes therein and U-shaped oxidant gas flow channels;

FIG. 2 is a perspective view of the opposing second side of the exemplary bipolar interconnection plate of FIG. 1 illustrating the fuel gas flow channels;

FIG. 3 is an enlarged schematic cross-sectional view of a portion of the bipolar interconnection plate of FIG. 1 taken along line 3-3 of FIG. 2;

FIG. 4 is a schematic of a conventional micro heat pipe showing the principle of operation and circulation of the working fluid therein which may be fabricated and incorporated in an exemplary bipolar interconnection plate constructed in accordance with the present invention; and

FIG. 5 is a front perspective partially exploded schematic view of a stacked, multiple fuel cell power generation system having a plurality of fuel cell units therein which are separated from each other by bipolar interconnection plates constructed in accordance with the invention including embedded micro heat pipes.

### DETAILED DESCRIPTION OF THE PREFERRED EMBODIMENTS

Reference is now made to the accompanying figures for the purpose of describing, in detail, the preferred embodiments of the present invention. Unless otherwise apparent, or stated, positional references, such as “upper” and “lower”, are intended to be relative to the orientation of the embodiment as first shown in the figures. Also, a given reference numeral should be understood to indicate the same or a similar structure when it appears in different figures.

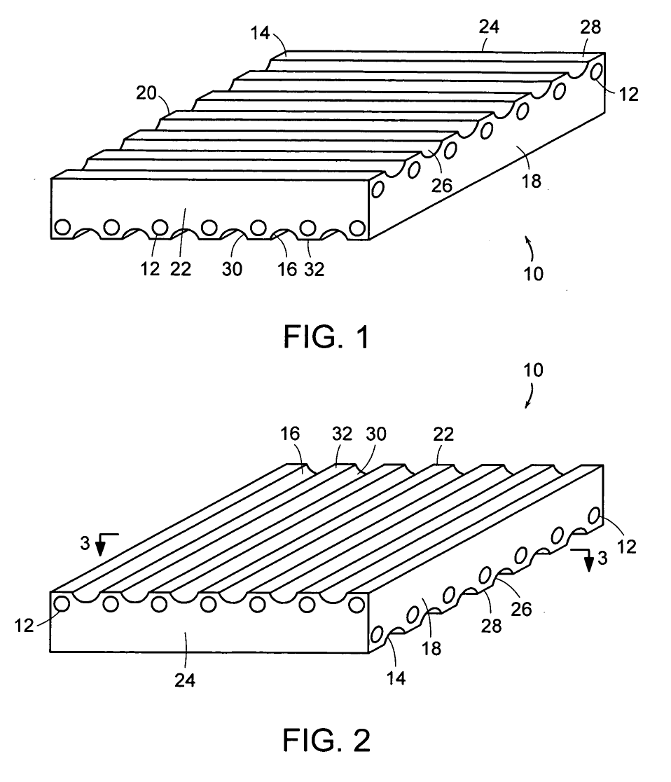

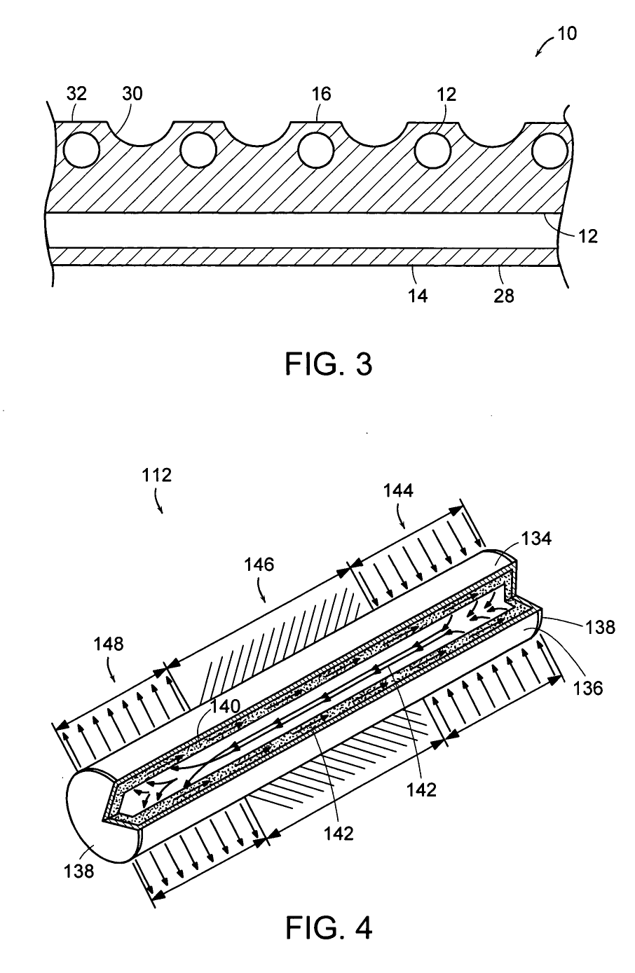

FIGS. 1-3 illustrate an exemplary bipolar interconnection plate 10 constructed with a plurality of embedded micro heat pipes 12 in accordance with the present invention. Plate 10 is generally rectangular and planar but its shape and size is not limited to any particular dimensional characteristics. The size and shape of plate 10 can vary depending on the desired size and electrical generation capabilities of the fuel cell power system in which it is to be used.

Plate 10 includes an upper or first side 14 and a lower or second side 16, which is substantially parallel to the first side 14, and planar opposing end faces 18, 20, 22, 24. First side 14 of plate 10 includes a plurality of indented portions that form elongate gas flow channels 26 and lands 28 therebetween. Channels 26 are configured to accommodate air or other oxidizing gases (e.g., O₂) during operation of the fuel cell system so that the electrochemical conversion of fuel materials can occur in accordance with conventional fuel cell technology as previously discussed. Channels 26 are substantially U-shaped and extend continuously along first side 14 of the plate 10 from the end face 18 to the end face 20. Lands 28 extend continuously along first side 14 adjacent channels 26 and form lands that establish a connection between the anode and cathode of adjoining fuel cells within a fuel cell stack, among other things.

As shown in FIG. 2, plate 10 has been rotated to illustrate second side 18 thereof. Second side 18 of plate 10 is similar to first side 16 in that it also includes a plurality of indented portions that form elongate, substantially U-shaped gas flow channels 30 and lands 32. Plate 10 of this embodiment is constructed so that it may be used on either side. However, for purposes of describing the features of the present invention, channels 30 will be considered the anode side, that is, configured to accommodate fuel materials (e.g., hydrogen, methane, etc.) for conducting electrochemical conversion in accordance with conventional fuel cell technology. Channels 30 extend continuously along second side 16 of plate 10 from the end face 22 to the end face 24. Lands 32 contact the adjacent fuel cell to establish the anode/cathode connection between adjoining fuel cells within the fuel cell stack, among other things. Preferably, each channel 30 extends along second side 16 in a substantially perpendicular relationship with respect to each channel 26 on first side 14.

It should be readily apparent that the number of channels 26 and 30 can vary depending on the size and character of the fuel cell system in which the plate 10 is being used, among other things. In addition, the cross-sectional shape of each channel 26 can be varied or the same, and may be other than U-shaped as depicted in this embodiment of the present invention, such as rectangular, V-shaped or semicircular. Preferably, the channels and lands are parallel to and equally spaced from each other. The depth of each channel or height of the lands can also vary, depending on a wide variety of operational parameters and spatial needs for accommodating micro heat pipes 12 and the gas or fuel flow. Plate 10 and fuel cell systems associated therewith shall not be limited to the use of any particular oxidizing gases or fuel materials.

In this embodiment, a bore extends longitudinally through plate 10 in each land 28 and 32 from end face 18 to end face 20, and end face 22 to end face 24, respectively. These bores are configured and dimensioned to receive and engage a micro heat pipe 12. As shown in this embodiment, micro heat pipes 12 are substantially cylindrical and embedded in axial and transverse directions with respect to first and second sides 14 and 16 of plate 10.

It should be readily apparent that there exists a wide variety of other geometries, configurations and amounts of micro heat pipes which may be incorporated in plate 10 or an interconnection bipolar plate of another shape and size in accordance with the present invention. Although heat pipes 12 are all shown as extending substantially the entire length of the plate 10 from end face to end face on either sides 14 and 16, interconnection plates constructed in accordance with the present invention may contain micro heat pipes of shorter length and the present invention should not limited to such configuration. Alternatively, it is envisaged that an additional member can be constructed in accordance with the present invention to include micro heat pipes 12 embedded therein and strategically placed in the fuel cell stack to assist with thermal management therein. Furthermore, the heat pipes discussed herein are referred to as being “micro” heat pipes merely for descriptive purposes and not to be taken as a limitation on the range of sizes for the heat pipes which may be constructed and employed in accordance with the present invention.

An exemplary micro heat pipe 112 that may be embedded in an interconnection bipolar plate in accordance with this invention is illustrated in FIG. 4. Heat pipes in general are comprised of a sealed container having an evaporator at one end and a condenser at an opposite end, with an external heat source operable to supply heat to the evaporator and an external heat sink operable to extract heat from the condenser.

Micro heat pipe 112 in FIG. 4 includes a sealed body 134 consisting of a pipe wall 136 and end caps 138. The internal surfaces of heat pipe 112 are all substantially lined with a wick structure 140 comprised of a fine porous material capable of transporting and distributing liquid by capillary action. Heat pipe 112 is filled with a quantity of phase change media or working fluid 142, which is in equilibrium with its own vapor.

During steady state operation the working fluid 142 is evaporated in the evaporator section 144 by heat applied thereto from an external heat source, which is conducted through pipe wall 136, as shown by the arrows at the exterior of pipe 112 in evaporator section 144 in FIG. 4. The vaporous working fluid 142, now containing the latent heat of evaporation, is driven by vapor pressure through sealed body 34 from evaporator section 144 through an adiabatic or transport section 146 to a condenser section 148, wherein the latent heat is given up for subsequent transfer through pipe wall 136 to the external heat sink, as shown by the arrows at the exterior of pipe 112 in condenser section 148. The working fluid 142 condenses upon rejection of the latent heat of evaporation and the condensate is collected in wick 140. Once inside wick 140, working fluid 142 is transported by capillary action and/or gravity through condenser section 148, transport section 146 to evaporator section 144 for another cycle. The movement of working fluid 142 throughout sealed body 134 is illustrated by the arrows in the interior of pipe 112 in FIG. 4. This process will continue as long as there is a sufficient capillary pressure to drive the condensed working fluid 142 back to evaporator section 144.

A heat pipe constructed in accordance with the present invention may have multiple heat sources or sinks with or without adiabatic sections depending on specific applications and designs. Preferably, the working fluid consists of a liquid metal, but other working fluids may be employed.

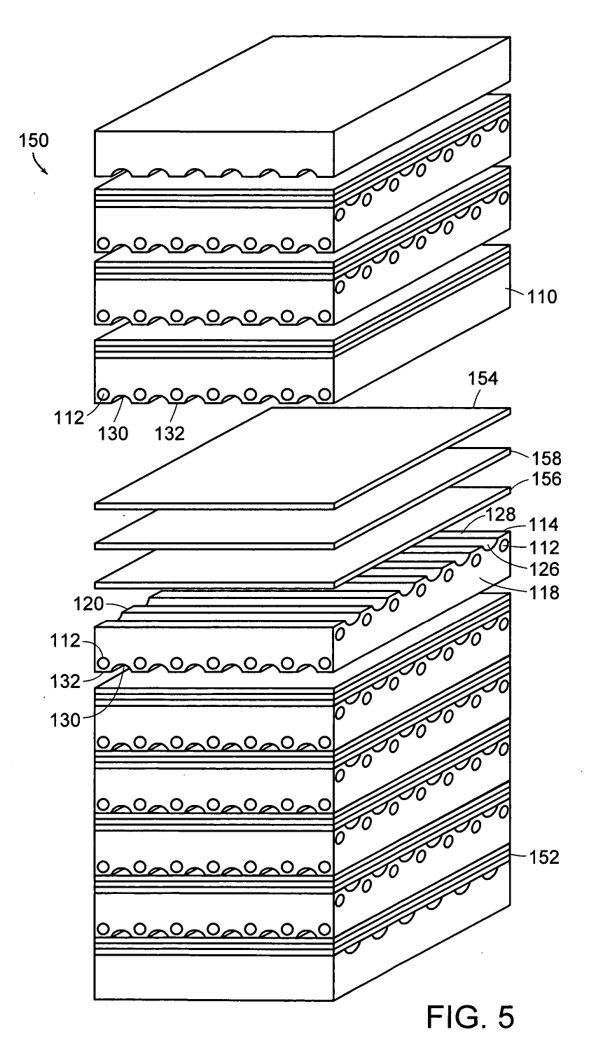

FIG. 5 illustrates an exemplary fuel cell stack 150 consisting of multiple fuel cells 152. Each of the fuel cells 152 are separated and electrically interconnected to an adjacent fuel cell 152 by a bipolar interconnection plate 110 including a plurality of micro heat pipes 112 embedded therein in accordance with an exemplary embodiment of the present invention.

Each fuel cell 152 comprises an anode member 154 and a cathode member 156 separated by a solid electrolyte material 158. As indicated above, the present invention shall not be limited to use in connection with any particular fuel cell system, and is prospectively applicable to a wide variety of different systems. In this regard, the anode member 154, the cathode member 156, and the portion of electrolyte material 158 is not meant to be limited to any particular dimensional characteristics, construction materials, or attachment methods relative to plate 110 and other components of the system.

First side 114 of each plate 110 which includes the gas flow channels 126 and lands 128 is positioned so that lands 128 are in contact with cathode member 132 of one of the fuel cell units 152 in stack 150. Likewise, the second side 116 of each plate 110, which includes the fuel flow channels 130 and lands 132 is positioned so that lands 132 are in contact with the anode member 154 of another one of the fuel cell units 152 in stack 150. As a result, an integrated stack 150 of fuel cell units 152 is created having improved thermal management via bipolar plates 110 therebetween.

Heat generated by reactions in each fuel cell 152 is distributed by the plurality of heat pipes 112 in each bipolar plate 110, in the manner described above. Large quantities of heat can be transferred as compared with prior systems, such as those which involved single phase heat transfer. Also, the addition of the micro heat pipes 112 to bipolar plates 110 achieves better thermal management without unduly increasing the size or weight of stack 150, or impairing the structural integrity of stack 150. The present invention may be applied to all temperature ranges of fuel cells, from polymer electrolyte to solid oxide, in conditions where micro heat pipes using liquid metal working fluid would be employed.

The bipolar plates may be fabricated with bores and the micro heat pipes sealed therein by any conventional method such as laser drilling (e.g., as in the case of a machined bipolar plate). For slurry-molded bipolar plates, a temporary preform of rods sized for the micro heat pipes can be embedded in the slurry. The preform would be removed from the molded bipolar plate by heating, for example. The micro heat pipe may be sealed in the bores by any conventional technique, such a highly thermally conductive epoxy or brazing. The bipolar plates and heat pipes may be constructed of carbon, metal, mixed metal products, combinations thereof, or any other material having characteristics that would render it practical for implementation in a fuel cell stack in a manner according to the teachings of the present invention.

Although exemplary and preferred aspects and embodiments of the present invention have been described with a full set of features, it is to be understood that the disclosed system and method may be practiced successfully without the incorporation of each of those features. It is to be further understood that modifications and variations may be utilized without departure from the spirit and scope of this inventive system and method, as those skilled in the art will readily understand. Such modifications and variations are considered to be within the purview and scope of the appended claims and their equivalents.

1. A bipolar interconnection plate for placement between fuel cell units in a fuel cell stack having multiple fuel cell units to form a power generation system, each fuel cell unit including an anode member, a cathode member, and a portion of electrolyte material positioned between the anode member and the cathode member, the bipolar interconnection plate comprising:
(a) a generally planar support member having opposing first side and second side surfaces;
(b) an elongate channel and lands adjacent thereto defined on the first side surface of the support member;
(c) an elongate channel and lands adjacent thereto defined on the second side surface of the support member; and
(d) a heat pipe disposed in the planar support member for receiving and distributing heat in the fuel cell stack.

2. A bipolar interconnection plate as recited in claim 1, wherein the heat pipe is substantially embedded in one of the lands defined on either the first side surface or the second side surface.

3. A bipolar interconnection plate as recited in claim 1, wherein a first heat pipe is embedded within one of the lands on the first side surface and a second heat pipe is embedded within one of the lands on the second side surface.

4. A bipolar interconnection plate as recited in claim 1, further comprising a plurality of elongate channels defining a longitudinal array of lands adjacent thereto on the first side surface and a plurality of elongate channels defining a longitudinal array of lands adjacent thereto on the second side surface.

5. A bipolar interconnection plate as recited in claim 4, further comprising a heat pipe embedded in each of the longitudinal lands defined by the plurality of elongate channels on the first side surface and a heat pipe embedded in each of the longitudinal lands defined by the plurality of elongate channels on the second side surface.

6. A bipolar interconnection plate as recited in claim 5, wherein the plurality of elongate channels and array of longitudinal lands with embedded heat pipes on the first side of the support member and the plurality of elongate channels and array of longitudinal lands with embedded heat pipes on the second side of the support member are in a perpendicular relationship with respect to each other.

7. A bipolar interconnection plate as recited in claim 6, wherein the heat pipes extend substantially the length of the support member.

8. A bipolar interconnection plate as recited in claim 1, wherein the elongate channel is substantially U-shaped.

9. A bipolar interconnection plate as recited in claim 1, wherein the heat pipe contains a working fluid that comprises liquid metal.

10. A fuel cell stack including multiple fuel cell units forming a power generation system, wherein each fuel cell unit includes an anode member, a cathode member, and a portion of electrolyte material positioned between the anode member and the cathode member, and a bipolar interconnection plate for placement between at least one pair of adjacent fuel cell units in the fuel cell stack, the bipolar interconnection plate comprising:
(a) a generally planar support member having opposing first side and second side surfaces;
(b) a plurality of elongate channels and lands defined adjacently thereto on the first side surface of the support member;
(c) a plurality of elongate channels and lands defined adjacently thereto on the second side surface of the support member; and
(d) a first heat pipe disposed within at least one of the lands of the first side of the support member and a second heat pipe disposed within at least one of the lands of the second side of the support member for receiving and distributing heat within the fuel cell stack.

11. A fuel cell stack as recited in claim 10, wherein the lands and channels on the first side surface are defined substantially perpendicular with respect to the lands and channels on the second side surface.

12. A fuel cell stack as recited in claim 11, further comprising a heat pipe disposed within each of the lands of the first side of the support member and a heat pipe disposed within each of the lands of the second side of the support member.

13. A fuel cell stack as recited in claim 10, wherein the heat pipe is substantially embedded in the support member.

14. A fuel cell stack as recited in claim 10, wherein the bipolar interconnection plate is placed between each fuel cell unit.

15. A method for constructing a bipolar interconnection plate comprising the steps of:
(a) providing a machined bipolar interconnection plate comprising:
(i) a planar support member having opposing first side and second side surfaces;
(ii) an array of elongate channels and lands adjacent thereto defined on the first side surface of the support member;
(iii) an array of elongate channels and lands adjacent thereto defined on the second side surface of the support member;
(b) forming a bore through the support member in the area of at least one of the lands on the first side of the support member; and
(c) securing a heat pipe within the bore.

16. The method according to claim 15, further comprising the steps of:
(d) forming a bore through the support member in the area of at least one of the lands on the second side of the support member; and
(e) securing a heat pipe within the bore.

17. The method according to claim 16, further comprising the step of”
(f) sealing the heat pipes within the bores with a highly thermally conductive epoxy.

18. The method according to claim 15, wherein the step of forming a bore through the support member in the area of at least one of the lands on the first side of the support member comprises laser drilling the bore.
